(19) United States
(12) Patent Application Publication
(10) Pub. No.: US 2025/0309958 A1
(43) Pub. Date: Oct. 2, 2025

(54) PROCESSING MEASUREMENT PREDICTIONS ASSOCIATED WITH BEAMS

(71) Applicant: Apple Inc., Cupertino, CA (US)

(72) Inventors: Konstantinos Sarrigeorgidis, Los Gatos, CA (US); Jie Cui, San Jose, CA (US); Manasa Raghavan, Sunnyvale, CA (US); Xiang Chen, Campbell, CA (US); Yang Tang, San Jose, CA (US)

(73) Assignee: Apple Inc., Cupertino, CA (US)

(21) Appl. No.: 18/619,134

(22) Filed: Mar. 27, 2024

(51) Int. Cl. H04B 7/06; H04L 5/00; H04W 24/08

(52) U.S. Cl. CPC H04B 7/0626; H04L 5/0048; H04W 24/08

(57) ABSTRACT

The present application relates to devices and components including apparatus, systems, and methods to process beam measurement predictions associated with beams. In an example, a network configures a UE with different configurations: one for measuring reference signals on a first set of beams, and one for performing beam measurement predictions for a second set of beams. Upon receiving reference signals on the first set of beams, the UE can generate beam measurements. The UE can also execute an AI model that outputs the beam measurement predictions based on an input that includes the beam measurements. The UE can be further configured to report the beam measurement predictions and/or to determine, based on such predictions, particular beams on which additional reference signals are to be received. In the latter case, upon receiving reference signals, the UE can generate and report the corresponding beam measurements.

### BACKGROUND

Cellular communications can be defined in various standards to enable communications between a user equipment and a cellular network. For example, Fifth Generation mobile network (5G) is a wireless standard that aims to improve upon data transmission speed, reliability, availability, and more. In such a network, directional antenna beams can be used. Beam management can be implemented to focus the antenna's energy in specific directions, therefore improving, among other things, spectral efficiency and coverage.

### BRIEF DESCRIPTION OF THE DRAWINGS

FIG. 1 illustrates an example of a network environment, in accordance with some embodiments.

FIG. 2 illustrates an example of beam configurations, in accordance with some embodiments.

FIG. 3 illustrates an example of data collection to train an artificial intelligence (AI)-machine learning (ML) model for beam management prediction, in accordance with some embodiments.

FIG. 4 illustrates an example of inference using an AI-ML model to generate beam measurement predictions, in accordance with some embodiments.

FIG. 5 illustrates an example of a sequence diagram for configuring a UE to report beam measurement predictions, in accordance with some embodiments.

FIG. 6 illustrates an example of inference using an AI-ML model to generate beam measurement predictions for certain beams, where at least some actual beam measurements exist for these beams, in accordance with some embodiments.

FIG. 7 illustrates an example of a sequence diagram for processing beam measurement predictions, in accordance with some embodiments.

FIG. 8 illustrates an example of a sequence diagram for reporting beam measurement predictions, in accordance with some embodiments.

FIG. 9 illustrates an example of a sequence diagram for a life cycle management procedure based on beam measurements and beam measurement predictions, in accordance with some embodiments.

FIG. 10 illustrates an example of an operational flow/algorithmic structure for beam reporting, in accordance with some embodiments.

FIG. 11 illustrates another example of an operational flow/algorithmic structure for beam reporting, in accordance with some embodiments.

FIG. 12 illustrates an example of receive components, in accordance with some embodiments.

FIG. 13 illustrates an example of a UE, in accordance with some embodiments.

FIG. 14 illustrates an example of a base station, in accordance with some embodiments.

### DETAILED DESCRIPTION

Embodiments of the present disclosure are directed to, among other things, processing beam measurement predictions associated with beams. Generally, a user equipment (UE) can communicate with a base station to access a cellular network (e.g., a 5G cellular network). The communication can rely on beams emitted by the base station, whereby at least the beam having the best quality (e.g., based on reference signal (RS) measurements) is selected and used for the communication. Beam reporting can be performed repeatedly over time and can indicate the quality of particular beams to help with the selection of the beam(s) to use. To do so, the base station can send configuration information about two sets of beams to the UE. The first set can indicate A beams (e.g., by including their corresponding beam indices). The second set can indicate B beams (e.g., by also including the corresponding beam indices). The set B can be a subset of the set A. The configuration information can also indicate configurations for reference signals (e.g., including channel state information (CSI) reference signals) to be measured on beams of the set B and reported to the base station. Further, the configuration information can indicate configurations for measurement predictions on beams of the set A (e.g., the top K beams of the set A that have the best beam measurement predictions) and reported to the base station. Some of the K beams may also belong to the set B when this set is a subset of the set A. The beam measurement predictions can be output by an artificial intelligence (AI) machine learning (ML) model executed by the UE. The input to the AI-ML model can include the B beam measurements. Depending on the configuration information, the UE can differentiate between the B beam measurements (e.g., actual reference signal received power (RSRP) measurements of CSI-RS received on the B beams) and K beam measurement predictions (e.g., output by the AI-ML model based on the actual RSRP measurements). When reporting about the qualities of the beams (e.g., when sending a CSI-RS report), the UE can report the B beam measurements and the K beam measurement predictions (e.g., in two separate CSI-RS reports, or in the same CSI-RS report that distinguishes between the two). Additionally, or alternatively, out of top K beam measurement predictions, L beam measurement predictions correspond to L beams that are excluded from the set B. In this case, and based on the configuration information, the base station can transmit additional reference signals (e.g., CSI-RS) on these L beams, and the UE can perform the corresponding beam measurements and report them to the base station. When both the beam measurements and the beam measurement predictions for the same set of beams (e.g., the L beams) are reported, a comparison between the two can be performed to determine a performance of the AI-ML model. Based on the performance (e.g., when it degrades below a threshold performance metric), a change to the AI-ML model, use of the AI-ML model, and/or configuration information can be performed as part of a life cycle management (LCM) procedure. These and other features of the present disclosure are further described herein below.

Embodiments of the present disclosure provide several technical improvements. For example, the embodiments enable the base station and the UE to determine the beams having the best qualities (e.g., the top K beams) based on both actual beam measurements and beam measurement predictions. Each of such beams is determined based on knowledge about whether an actual beam measurement and/or a beam measurement prediction is reported. Further, through the LCM procedure, improvements to the reporting can be made.

Embodiments of the present disclosure are described in connection with 5G networks. However, the embodiments are not limited as such and similarly apply to other types of communication networks including other types of cellular networks.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

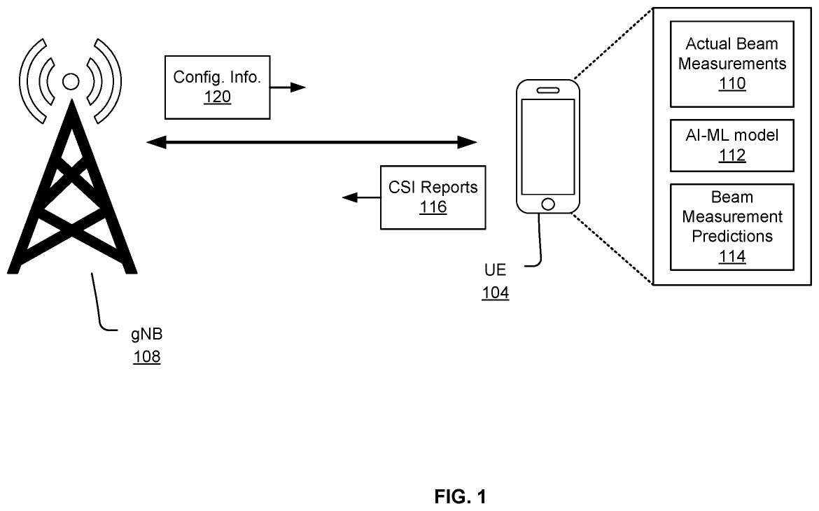

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal block (SSB). The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include CSI-RS. The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs (for example, six REGs).

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data), and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

In an example, the communication between the gNB 108 and the UE 104 relies on beam management. The beam management can involve, among other things, beamforming, beam reporting, beam steering, beam switching, beam tracking, and beam management signaling. As part of the beam reporting, the gNB 108 can send configuration information 120 to the UE 104. The configuration information 120 can configure the UE 104 to perform actual beam measurements 110 of reference signals (e.g., CSI-RS) received on beams that belong a set of beams (referred to herein as a set B). The configuration information 120 can also configure the UE 104 to perform beam measurement predictions 114 for another set of beams (referred to herein as a set A). The beam measurement predictions 114 can be generated by an AI-ML model 112 executing on the UE 104 (e.g., executed by a processor of the UE 104). The UE 104 can report the beam qualities (measured and/or predicted) in for example, one or more CSI reports 116. For example, the actual beam measurements 110 (e.g., actual RSRP measurements derived from measurements on the CSI-RS transmitted on the B beams) can be reported in one CSI report. In comparison, the top K predicted beam measurements (e.g., predicted RSRP measurements, where such predictions are output by the AI-ML model 112 based on the actual RSRP measurements) can be reported in a different CSI report (where K can be configured by the configuration information 120 or can be a setting of the AI-ML model 112). Alternatively, the actual beam measurements 110 and the top K predicted beam measurements can be reported in the same CSI report. Additionally, or alternatively, for at least some of the beams for which the UE 104 generates beam measurement predictions, the gNB 108 can transmit additional reference signals on such beams. In turn, the UE 104 can generate actual beam measurements using the additional reference signals and can report them in a CSI report.

The use of an AI-ML model is described in the present disclosure. However, embodiments of the present disclosure are not limited as such. For example, any type of AI model (which may not be an ML model) can be used, whereby the AI model is configured to support beam management (e.g., configured to generate beam measurement predictions). The embodiments similarly and equivalently apply to such an AI model.

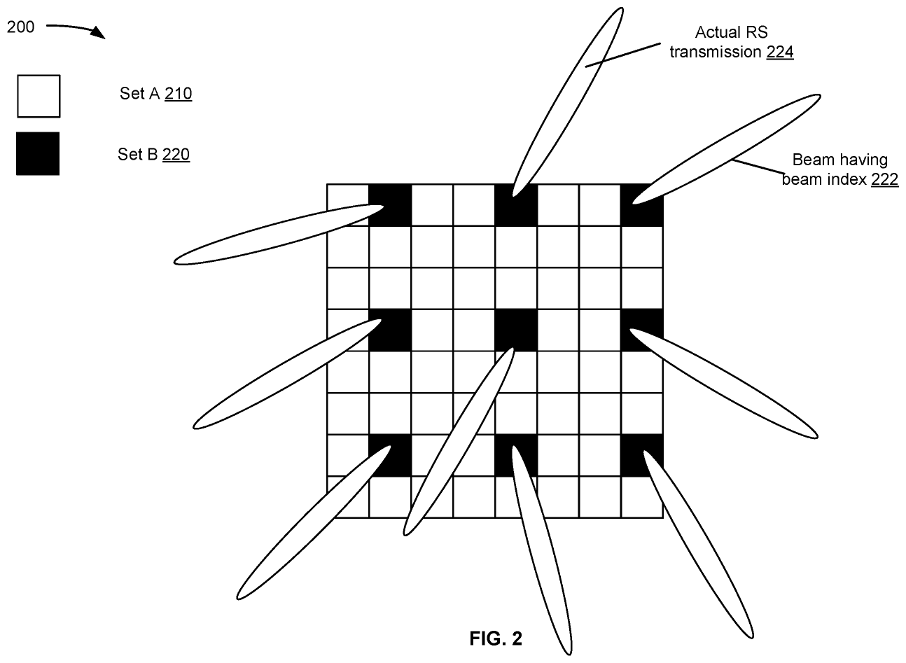

FIG. 2 illustrates an example of beam configurations 200, in accordance with some embodiments. The beams configurations 200 can be indicated by configuration information sent from a base station to a UE (e.g., the configuration information 120 sent from the gNB 108 to the UE 104 of FIG. 1). In particular, the configuration information can indicate, among other things, two sets of beams (e.g., illustrated as a set A 210 of beams and a set B 220 of beams). The set B 220 can be a subset of the set A 210. In the interest of clarity of explanation, the size of the set A 210 is referred to herein as A. Similarly, the size of the set B 230 is referred to herein as B.

In an example, each beam has a beam index 222. In this example, the configuration information includes the beam indices belonging to the set B 220 and the beam indices belonging to the set A 210. Additionally, or alternatively, the information of which beams from set A 210 are used to construct set B 220 can indicated in a bitmap or a list of CSI-RS resource indicators (CRIs) for the set B 220.

Generally, the set B 220 can correspond to the beams on which the base station is to transmit reference signals (e.g., CSI-RS), illustrated in FIG. 2 with an actual RS transmission 224 of one of the B beams, such that the UE can perform actual beam measurements of the reference signals (e.g., RSRP measurements). The set A 210 can correspond to the beams for which the UE is to generate beam measurement predictions (e.g., by inputting the actual beam measurements to an AI-ML model).

As illustrated in FIG. 2, the set A 210 includes the set B 220. Each of the beams can be an analog beam. The UE can generate beam measurement predictions for all beams belonging to the set A 210 (referred to herein as A beam measurement predictions, where A is a positive integer that refers to the size of the set A 210). For some of these beams (e.g., the ones belonging to the set B 220), the UE has also generated actual beam measurements (referred to herein as B beam measurement predictions, where B is a positive integer that refers to the size of the set B 220).

The UE can also be configured to report beam measurements and/or beam measurement predictions. In an example, the configuration information can indicate that the top K beam measurement predictions are to be reported and/or further processed. K is a positive integer equal to or smaller than A. The top K beam measurement predictions can refer to the K beam measurement predictions indicating the K beams out of the set A 210 that have the best predicted qualities. K can also depend on the configuration of the AI-ML model. For instance, K can be a condition or a parameter of the AI-ML model, where the top K beam measurement predictions of the AI-ML model can be considered to be sufficiently reliable under the operational environment (e.g., signal-to-noise ratio (SNR), Doppler effect, and/or delay spread).

In an example, the value of K can be dynamically updated based on the operational environment. For example, the smaller the SNR is, the larger the value of K can become. In particular, a decrease to the SNR indicates a noisier operational environment. The noisier the operational environment is, more reliability can be gained when a higher number of beam measurement predictions are processed. The dynamic update can be triggered by the base station open the base station detecting a change to the operational environment. The change to the value of K can be indicated via radio resource control (RRC) signaling, a media access control (MAC) control element (MAC CE) where, for example, RRC signaling configures multiple values for K and the MAC CE indicates which of these values is to be used, or DCI (similarly, RRC signaling configures multiple values for K and the DCI indicates which of these values is to be used). If K is a condition or a parameter of the AI-ML model, the UE can automatically trigger (e.g., by using predefined settings) the change to the value based on a detection of change to the operational environment.

Although a single set A-set B pair is illustrated in FIG. 2, the embodiments are not limited as such. Instead, the UE may be configured by the network with a single set A-set B pair per AI-ML model or multiple sets B for a given set A. The configurations may also depend on the UE capability regarding the AI-ML model and input types to the AI-ML model (e.g., RSRP measurements, reference signal received quality (RSRQ) measurements, signal-to-interference-plus-noise (SINR) measurements, etc.) that the UE can support.

In the interest of clarity of explanation, RSRP measurements are described in various embodiments of the present disclosure. However, the embodiments are not limited as such and, instead, equivalently apply to other measurement types (e.g., RSRQ, SINR, etc.). Generally, the AI-ML model is trained to predict a beam measurement. Depending on the type and/or training of the AI-ML model, the input can be any or a combination of the RSRP measurements, RSRQ measurements, SINR measurements, etc. The output can also be any or a combination of RSRP measurement predictions, RSRQ measurement predictions, SINR measurement predictions, etc.

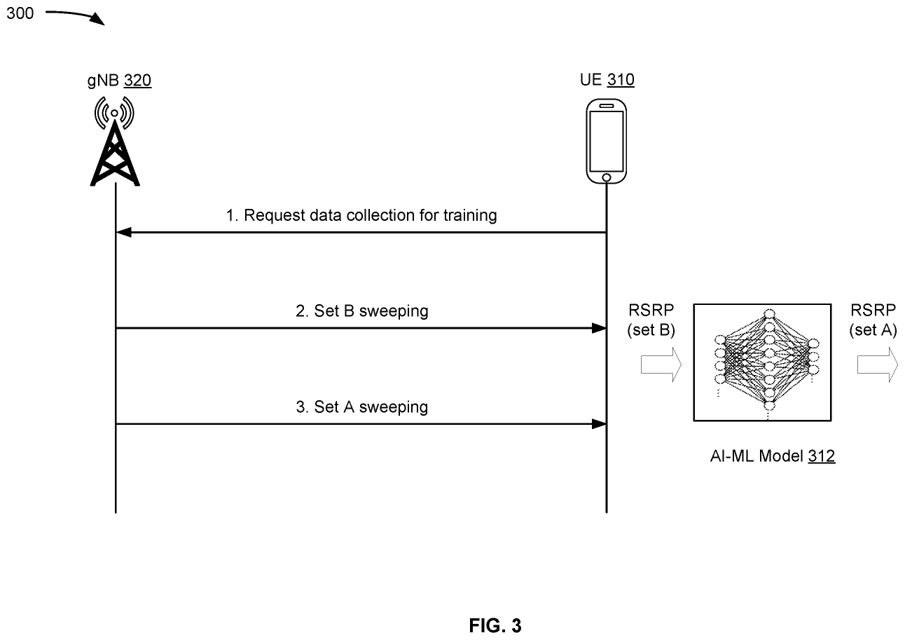

FIG. 3 illustrates an example of data collection 300 to train AI-ML model 312 for beam management prediction, in accordance with some embodiments. A UE 310 (an example of any of the UEs described herein) can execute the AI-ML model 312. A gNB 320 (an example of any base stations described herein) or, more generally, a network that includes the gNB 320, can collaborate with the UE 310 to perform the data collection 300. Once the data collection 300 is complete, the AI-ML model 312 can be trained or fine-tuned (e.g., its parameters, such as weights of node connections, can be updated). In FIG. 3, the data collection 300 and the training or fine tuning are described as being performed by the UE 310. However, it is possible that the UE 310 can send the collected data to the gNB 320. In turn, the gNB 320 (or, more generally, the network including possibly a network node different than the gNB 320) can perform the training or fine tuning and send an update applicable to the AI-ML model 312 (e.g., the updated parameters) to the UE 310.

A first step of the data collection 300 can be the UE 310 requesting the data collection 300 for training (or fine tuning). The UE 310 can do so in an offline manner. For data collection purposes, the network (e.g., the gNB 320) can configure reference signal resources (e.g., CSI-RS resources) for the UE (which can include sending configuration information to the UE, similar to the description of FIG. 2).

Next, the gNB 320 can perform beam sweeping on a set B of beams (e.g., the set B 220). The beam sweeping can include transmitting CSI-RS on configured CSI-RS resources over the beams. The UE 310 can perform beam measurements (e.g., RSRP measurements on the CSI-RS received on the beams of the set B). The UE 310 can also generate A beam measurement predictions by inputting the B beam measurements to the AI-ML model 312. The generate A beam measurement predictions are included in an output of the AI-ML model 312.

In a third step, the gNB 320 can perform beam sweeping on a set A of beams (e.g., the set A 210). The beam sweeping can include transmitting CSI-RS on configured CSI-RS resources over the beams. The UE 310 can perform beam measurements (e.g., RSRP measurements on the CSI-RS received on the beams of the set A). These A beam measurements can be used as training labels (e.g., as ground truth). At this point, the UE 310 has two value sets for the A beams: the A beam measurement predictions and the A beam measurements. Each pair of beam measurement prediction-beam measurement corresponds to one of the beams of the set A. An update algorithm can then be used to update the AI-ML model 312 based on a comparison of the values in each pair. This update algorithm can depend on the AI-ML model itself and can include, for example, a gradient descent algorithm based on a loss function, a reward algorithm based on reinforcement learning, etc.

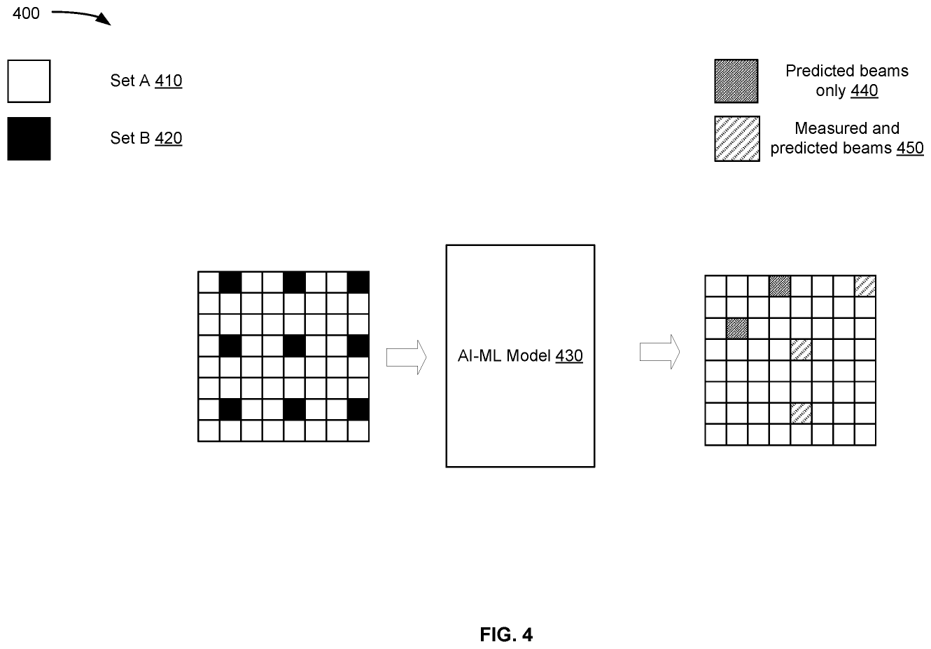

FIG. 4 illustrates an example of inference 400 using an AI-ML model 430 to generate beam measurement predictions, in accordance with some embodiments. Here, the AI-ML model 430 may have been trained (or fine-tuned) using the approach described in FIG. 3. A UE stores the AI-ML model 430 as executable program code. A network (e.g., a base station thereof) can configure the UE to measure reference signals sent on a set B 420 of beams to generate B beam measurements and to generate, by inputting the B beam measurements to the AI-ML model 430, beam measurement predictions for beams belonging to a set A 410 of beams, in manner similar to the description of FIG. 2. The configuration can also indicate that the UE is to further process the top K beam measurement predictions. The further processing can involve reporting these K beam measurement predictions and/or performing actual beam measurements on at least some of the K beams that are excluded from the set B. In FIG. 4, the input to the AI-ML model 430 is indicated with solid black squares. The output of the input to the AI-ML model 430 is indicated with dotted squares and diagonally dashed squares.

In an example, the set B 420 is included in the set A 410. Further, among the predicted set A 410 of beams, the UE may need to report the top K predicted beams (the RSRP predictions of the K beams that belong to the set A 410 and that have the K best values) to the network. It is possible that some of the top K predicted beams belong to the set B 420 for which the actual beam measurements are available. In FIG. 4, the top K predicted beams are with dotted squares and diagonally dashed squares. Among them (e.g., indicated by the diagonally dashed squares) are three beams that also belong to the set B 420. For this purpose, the diagonally dashed squares are labeled as measured and predicted beams 450 because these beams belong to both the set B 420 for which beam measurements exist and the set A for which beam measurement predictions exist. Other ones (e.g., indicated by the dotted squares) are two beams that only belong to the set A 410 (e.g., are excluded from the set B 410). For this purpose, the dotted squares are labeled as predicted beams only 440 because these beams belong to only the set A for which beam measurement predictions exist.

The UE can report the top K beams. The UE may also have the freedom of reporting the predicted and/or measured beams. Therefore, the uplink beam report needs to contain information on whether a reported beam is based on an actual measurement or based on an AI-ML prediction.

For example, when reporting the three beams corresponding to the three diagonally dashed squares, the UE may need to indicate whether the uplink beam report (e.g., CSI-RS report) includes beam measurements and/or predicted beam measurements for these beams. In comparison, when reporting the two beams corresponding to the two dotted squares, the UE may indicate that the uplink beam report (e.g., CSI-RS report) includes predicted beam measurements for these beams. If the UE performs beam measurements on additional reference signals sent on these two beams, uplink beam report can indicate whether the reported information corresponds to the actual beam measurements and/or the predicted beam measurements.

In many systems, a network can configure CSI reporting configurations, and the UE can report RSRP values and the CRIs associated with the best measurement beams. In the case of AI-ML predictions, the CSI-RS resources allocated for beam measurements and the predicted top K RSRPs may belong to different beams (the CRIs for predicted RSRPs may not be associated with the measured beam set). Since the UE only measures the beams in set B, and the AI-ML model predicts a beam from set A that may or may not be in set B, the uplink beam report from the UE may need to include details regarding whether the predicted beam was actually measured by the UE. Therefore, differentiating predicted beam reporting and measured beam reporting can be beneficial.

To enable the differentiation, a network can configure separate CSI reporting configurations (e.g., CSI-ReportConfigs). For example, and referring back to FIG. 2, the configuration information can indicate one set of reporting configurations (e.g. a CSI reporting configuration) for the set B 220 and a different set of reporting configurations (e.g., also a CSI reporting configuration) for the set A 210. Various reporting configurations (e.g., various CSI-ReportConfigs) can be configured for the UE, with one designated for measured beam reporting and another one designated for predicted beam reporting. The UE can then report (e.g., in a CSI-RS report) beam measurements based on the reporting configuration(s) designated for measured beam reporting. The UE can also report (e.g., in a different CSI-RS report, or in the same CSI-RS report with a “prediction” indication) beam measurement predictions based on the reporting configuration(s) designated for predicted beam reporting. Additionally, or alternatively, the UE could request the network (e.g., the base station) to transmit reference signals (e.g., aperiodic reference signals) on the predicted beams excluded from the set B but part of the set A. The UE can then conduct layer 1 (L1) measurements (e.g., RSRP measurements) on those beams and subsequently send a report of measured beams to the network (e.g., the base station). In addition, when the reporting is for both the predicted beams and the measured beams, the comparison of those two different types of beam reporting (e.g., specific to the predicted beams that were subsequently measured) can be leveraged as a metric for the purpose of LCM. These and other features of the present disclosure are further described herein below.

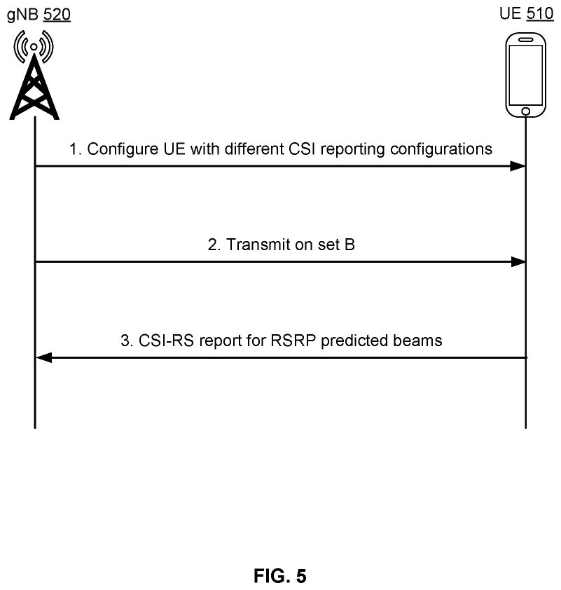

FIG. 5 illustrates an example of a sequence diagram 500 for configuring a UE 510 to report beam measurement predictions, in accordance with some embodiments. Here, a CSI-RS report is described as an example of an uplink beam report and is generated based on CSI-RS. Other types of uplink beam reports and/or reference signals can also be processed.

As illustrated in the sequence diagram 500, the gNB 520 (or, more generally, the network) configures the UE 510 with different CSI reporting configurations. For example, the gNB 520 can explicitly indicate the set B and its reporting configuration and explicitly indicate the set A and its reporting configuration. Alternatively, implicit signaling can be used.

Next, the gNB 520 transmits CSI-RS on the beams that belong to the set B. The UE 510 can generate RSRP measurements based on these CSI-RS. Further, the UE 510 can input the RSRP measurements to an AI-ML model trained for beam predictions. The AI-ML model can output RSRP measurement predictions for the set A of beams. The UE can determine the top K RSRP measurements out of the A RSRP measurement predictions.

In a third set of the sequence diagram 500, the UE can send, to the gNB 520, a CSI-RS report that includes the RSRPs of the top predicted K beams. Here, different options are available. In one example option, the UE 510 can send a CSI-RS specific to the beam measurement predictions (e.g., the top K RSRP measurement predictions and the corresponding CRIs). The UE can also send a separate CSI-RS report specific to the beam measurements (e.g., actual RSRP measurements and the corresponding CRIs). The UE 510 can indicate whether each of these two reports corresponds to actual measurements or measurement predictions. In a second example option, a single CSI-RS report can be sent. This CSI-RS report can include beam measurement predictions (e.g., the top K RSRP measurement predictions and the corresponding CRIs), beam measurements (e.g., actual RSRP measurements and the corresponding CRIs), and an indication per reported beam (e.g., per CRI), whether the corresponding value is an actual beam measurement or a beam measurement prediction. In a third example option, the UE 510 can determine which of the K beams are excluded from the set B. Assume that these beams for a set L. In this example option, the UE 510 sends a CSI-RS specific to the beam measurement predictions for the beams of the set L (e.g., the L RSRP measurement predictions and the corresponding CRIs). The UE can also send a separate CSI-RS report specific to the beam measurements (e.g., actual RSRP measurements and the corresponding CRIs).

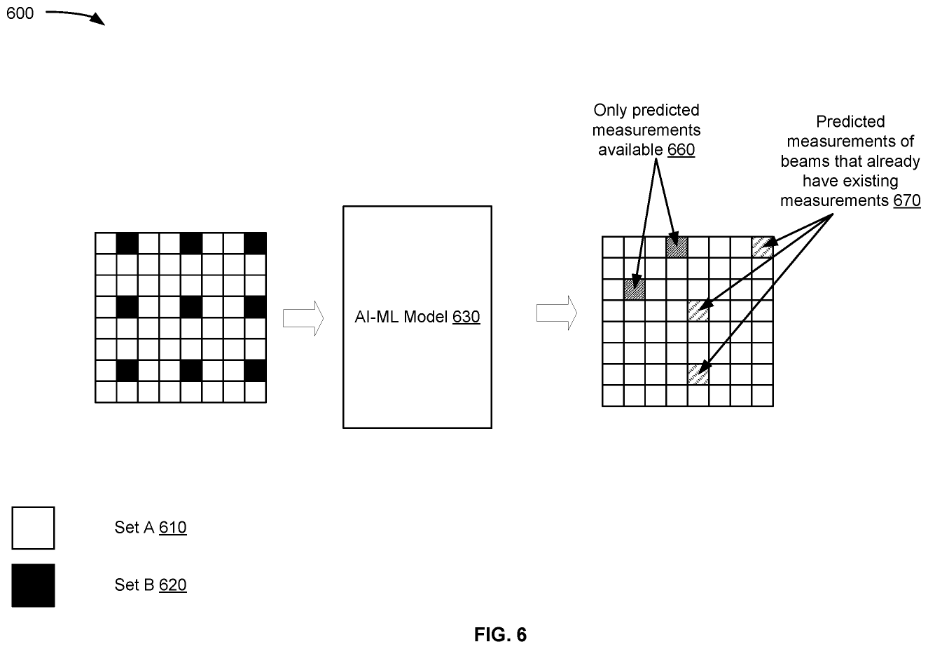

FIG. 6 illustrates an example of inference 600 using an AI-ML model 630 to generate beam measurement predictions for certain beams, where at least some actual beam measurements exist for these beams, in accordance with some embodiments. Like FIG. 4, a UE 610: a set A 610 for which beam prediction measurements (or, more specifically, the top K beam prediction measurements) are to be generated, and a set B 620 for which actual beam measurements are to be generated. The set B 620 can be a subset of the seat A 610. Here, however, for predicted beams that do belong to the set A 620 and do not belong to the set B 620, the UE 610 can request from the network (e.g., a gNB 620) the transmission of periodic or aperiodic reference signals for performing measurements on these predicted beams. Upon the reference signal transmission, the UE 610 can perform L1 measurements on those reference signals and subsequently send a report of the measured beams to the network.

In the interest of clarity, assume that the intersection between the top K predicted beams (e.g., the subset beams of the set A 610 having the best K RSRP measurement predictions) and the B beams (e.g., the beams that belong to the set B 620) forms a set L′ of beams. In other words, beams that belong to the set L′ have both beam measurements and beam measurement predictions. The difference between the top K predicted beams and the set L′ is a set L of beams. Beams belonging to the set L have only beam prediction measurements.

The different types of input to and output of the AI-ML model 630 are illustrated in FIG. 6 as follows. The solid squares indicate beam measurements of the set B 620. Their corresponding measurements are input to the AI-ML model 630. The output of the AI-ML model 630 includes K beam measurement predictions for beams (K is equal to five in FIG. 6 for illustrative purposes). Out of the K beam measurement predictions, three of them correspond to three beams that already have existing measurements 670. These three beams are accordingly measured and predicted beams (e.g., forming the set L′). Also, out of the K beam measurement predictions, the remaining ones (e.g., two beam prediction measurements in the example of FIG. 6) correspond to beams that belong to the set A 610 but not the set B 620 for which only predicted beam measurements 660 are available. These two beams are accordingly only predicted beams (e.g., forming the set L).

For the three beams belonging to the set L′, the UE can report their corresponding beam measurements. Additionally, or alternatively, the UE can report their corresponding beam measurement predictions. If these predictions are reported, the UE can indicate that they are predicted rather than being measured.

For the two beams belonging to the set L, the UE can request the network to transmit reference signals on these beams (e.g., aperiodic CSI-RS). Alternatively, the network can determine (e.g., from the beam measurement predictions if they are reported) the two beams and transmit the reference signals absent an explicit UE request for them. In both cases, upon receiving the two reference signals, the UE can perform and then report actual measurements thereon. Additionally, or alternatively, the UE can report their corresponding beam measurement predictions. If these predictions are reported, the UE can indicate that they are predicted rather than being measured.

Accordingly, the UE performs beam measurements on the set B 620 first to then use these beam measurements as input to the AI-ML model 630. Out of the top K beam measurement predictions that are output by the AI-ML model 630, the UE can determine the ones that correspond to the set L. For the beams of the set L, the UE can request and/or automatically receive additional reference signals to generate actual beam measurements. In a way, the output of the AI-ML model 630 is used to determine which additional beams need to be measured.

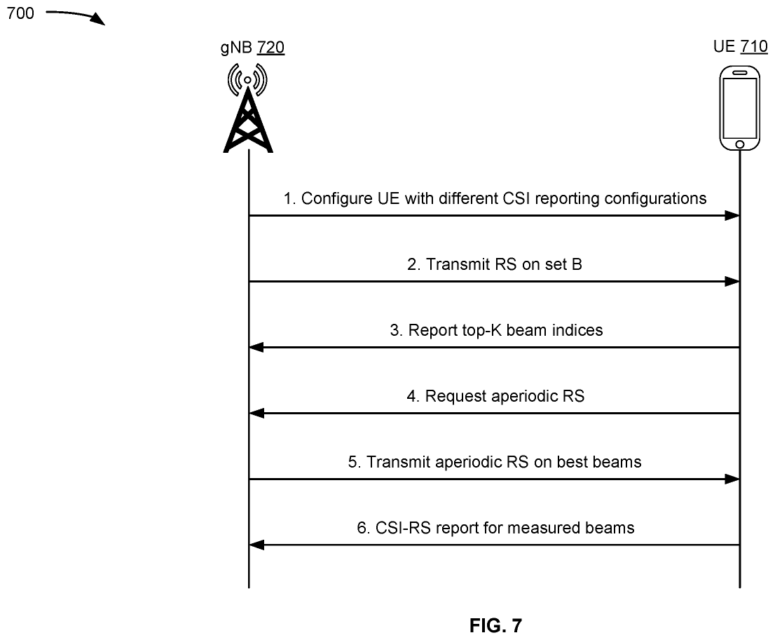

FIG. 7 illustrates an example of a sequence diagram 700 for processing beam measurement predictions, in accordance with some embodiments. Some of the steps of the sequence diagram 700 are similar to those of the sequence diagram 500 of FIG. 5. The similarities are not repeated in the interest of brevity, but the corresponding descriptions of FIG. 5 equivalently apply here. Also here, a CSI-RS report is described as an example of an uplink beam report and is generated by performing RSRP measurements of received CSI-RS. Other types of uplink beam reports, beam measurements, and/or reference signals can be processed.

As illustrated in the sequence diagram 700, a gNB 720 (or, more generally, the network) configures a UE 710 with different CSI reporting configurations, one for a set A of beams and one for a set B of beams, where the set B can be a subset of the set A. Next, the gNB 720 transmits CSI-RS on the beams that belong to the set B. The UE 710 can generate RSRP measurements based on these CSI-RS. Further, the UE 710 can input the RSRP measurements to an AI-ML model trained for beam predictions. The AI-ML model can output RSRP measurement predictions for the set A of beams. The UE can determine the top K RSRP measurement predictions out of the A RSRP measurement predictions.

In a third set of the sequence diagram 700, the UE 710 can report, to the gNB 720 (or, more generally, the network), the top K beam indices based on the AI-ML predictions. These indices correspond to the predicted beams of the set A having the top K beam measurement predictions. Additionally, the UE 710 can request the gNB 720 to transmit aperiodic reference signals on the predicted beams not included in the set B but are part of the set A. In particular, the UE 710 can determine the beams that form a set L as described herein above. This request can be separate from the report of the top K beam indices. Alternatively, the request is implicit in the report of the top K beam indices, where the gNB 720 can determine the L beams of the top K beams having indices belonging to the set A but not the set B.

Next, the gNB 720 (or, more generally, the network) can transmit CSI-RS (e.g., aperiodic CSI-RS) on the L beams. It is possible that the gNB 720 can transmit CSI-RS on the top K predicted beams. In both cases, the UE 710 can perform measurements on the CSI-RS received on the predicted beams (e.g., the L beams in the former case, and the top K beams in the latter case). The UE 710 can send, to the gNB 720 (or, more generally, the network), a report including the RSRPs of all measured beams (e.g., the beam measurements corresponding to the set B, in addition to the beam measurements corresponding to the set L or the top K beams).

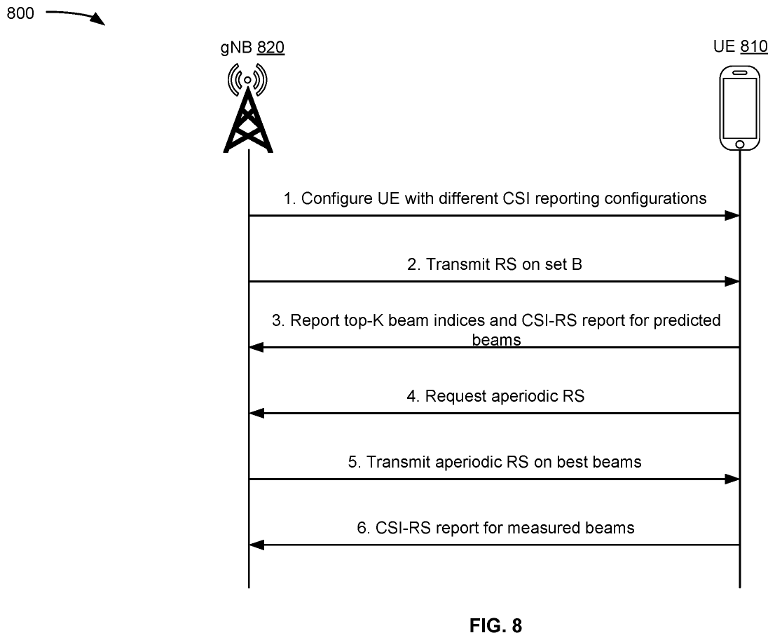

FIG. 8 illustrates an example of a sequence diagram 800 for reporting beam measurement predictions, in accordance with some embodiments. Some of the steps of the sequence diagram 800 are similar to those of the sequence diagram 700 of FIG. 7. The similarities are not repeated in the interest of brevity, but the corresponding descriptions of FIG. 7 equivalently apply here. Unlike in FIG. 7, the sequence diagram 800 of FIG. 8 results in a UE 820 reporting beam measurements and beam measurement predictions. Also here, a CSI-RS report is described as an example of an uplink beam report and is generated by performing RSRP measurements of received CSI-RS. Other types of uplink beam reports, beam measurements, and/or reference signals can be processed.

As illustrated in the sequence diagram 800, the gNB 820 (or, more generally, the network) configures a UE 810 with different CSI reporting configurations, one for a set A of beams and one for a set B of beams, where the set B can be a subset of the set A. Next, the gNB 820 transmits CSI-RS on the beams that belong to the set B such that the UE 810 can generate RSRP measurements based on these CSI-RS, generate RSRP measurement predictions for the set A of beams, and determine the top K RSRP measurement predictions.

In a third set of the sequence diagram 800, the UE 810 can report, to the gNB 820 (or, more generally, the network), the top K beam indices based on the AI-ML predictions as well as a CSI-RS report that includes the RSRP measurement predictions of the top K predicted beams. Additionally, the UE 810 can request the gNB 820 to transmit aperiodic reference signals on the predicted beams not included in the set B but are part of the set A (forming a set L of beams).

Next, the gNB 820 (or, more generally, the network) can transmit CSI-RS (e.g., aperiodic CSI-RS) on the L beams. It is possible that the gNB 820 can transmit CSI-RS on the top K predicted beams. In both cases, the UE 810 can perform measurements on the CSI-RS received on the predicted beams (e.g., the L beams in the former case, and the top K beams in the latter case). The UE 810 can send, to the gNB 820 (or, more generally, the network), a report including the RSRPs of all measured beams.

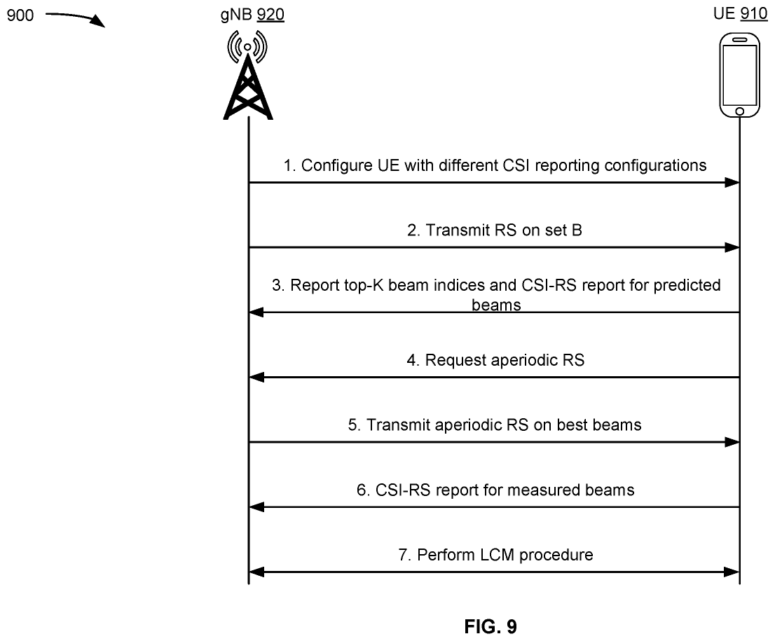

FIG. 9 illustrates an example of a sequence diagram 900 for an LCM procedure based on beam measurements and beam measurement predictions, in accordance with some embodiments. Some of the steps of the sequence diagram 900 are similar to those of the sequence diagram 800 of FIG. 8. The similarities are not repeated in the interest of brevity, but the corresponding descriptions of FIG. 8 equivalently apply here. Upon reporting both beam measurements and beam measurement predictions (e.g., as in FIG. 8), the sequence diagram 900 of FIG. 9 further includes triggering an LCM procedure based on a comparison of the beam measurements and the beam measurement predictions. Also here, a CSI-RS report is described as an example of an uplink beam report and is generated by performing RSRP measurements of received CSI-RS. Other types of uplink beam reports, beam measurements, and/or reference signals can be processed.

The first six steps of the sequence diagram 900 are similar to the corresponding steps of the sequence diagram 800. As further illustrated in FIG. 9, the sequence diagram 900 involves a seventh step, whereby based on a comparison of the beam measurements and beam measurement prediction, an LCM procedure can be triggered and possibly performed. In particular, a UE 910 reports, to a gNB 920 (or, more generally, the network) its beam measurements for a set B, its beam measurement predictions for the top K predicted beams of a set A, and its beam measurements for the set L formed by thy the subset of the top K predicted beams that do not belong to the set B. As such, for each beam of the set L, the gNB 920 (or, more generally, the network) has a value pair: an actual beam measurement (e.g. a measured RSRP value) and a beam measurement prediction (e.g., an RSRP value predicted by an AI-ML model of the UE 910). A performance metric can be generated based on the comparison of the values within each value pair. For instance, the performance metric can be a statistical measure of the differences between the values in the pairs (e.g., the average difference across the value pairs). The performance metric can be compared to a threshold performance. If the performance metric exceeds the threshold performance, the LCM procedure may not be triggered. Otherwise, the performance metric has fallen below the threshold performance. Therefore, the LCM procedure can be triggered.

Generally, the LCM procedure can involve any or a combination of a change to the use of the AI-ML model, a change to the AI-ML model itself, or a change to the configuration for the beam measurements (e.g., a change to the set B and/or a change to the value of K). These different possible LCM procedures are described herein next.

In one example, the gNB 920 (or, more generally, the network), can indicate (e.g., via RRC signaling or other type of signaling) to deactivate the AI-ML model. In this case, the UE 910 stops using (or terminates the execution of) the AI-ML model and, instead, defaults to only measuring reference signals received on the beams of the set B and reports only the corresponding beam measurements. Additionally, or alternatively, the UE 910 can determine the performance metric, compare it to the performance threshold, deactivate the AI-ML model, and indicate the deactivation to the gNB 920.

In another example, the gNB 920 (or, more generally, the network), can indicate to the UE 910 an update to the AI-ML model (e.g., via RRC signaling or other signaling). The update here can instruct the UE 910 to switch to using a different AI-ML model, initiate a procedure to transfer a new AI-ML model, initiate a procedure to transfer updated parameters for the AI-ML model, or initiate a new data collection and training or fine tuning procedure. Additionally, or alternatively, the UE 910 can determine the performance metric, compare it to the performance threshold, initiate the update to the AI-ML model, and indicate this update or the underlying update procedure or request for it to the gNB 920.

In yet another example, the gNB 920 (or, more generally, the network), can indicate to the UE 910 an update to value of K (e.g., via RRC signaling or other signaling). The update here can instruct the UE 910 to change the value of K (e.g., to increase it by a predefined increment or by a particular increment). Here, the gNB 920 can also determine an operational condition (e.g., SNR, Doppler effect, or delay spread) and dynamically adjust the value of K accordingly by indicating the relevant change to the UE 910. Additionally, or alternatively, the UE 910 can determine the performance metric, compare it to the performance threshold, change the value of K, and indicate this change to the gNB 920.

In a further example, the gNB 920 (or, more generally, the network), can indicate to the UE 910 an update to value the configuration for beam reporting (e.g., via RRC signaling or other signaling). The update here can instruct the UE 910 to change the set B (e.g., to change the beams that belong to this set or change the size of this set). Additionally, or alternatively, the UE 910 can determine the performance metric, compare it to the performance threshold, change the configuration of the set B, and indicate this change to the gNB 920.

In the last two examples (change to the K configuration and change to the set B configuration), AI modeling can be used to determine the change. In particular, upon a degradation of the performance of the UE's 910 AI-ML model, a change to K and/or the set B is made. In addition, if the change results in an improvement to the performance of the UE's 910 AI-ML model (e.g., the resulting performance metric exceeds the threshold performance or the previously determined performance metric), a reward is set. Otherwise, a penalty is set. This type of changes can be tracked over time in addition to other information (e.g., the operational conditions) to set rewards and penalties. Reinforcement learning can then be used to train an AI model for outputting the change to the K configuration and/or the change to the set B configuration from that point on. As such, when subsequently the performance of the UE's 910 AI-ML model degrades (e.g., falls below the threshold performance), the AI model can be invoked (e.g., by inputting thereto the latest beam measurements and beam measurement predictions, the performance metric, and/or other information such as the current operational condition(s)) to then receive an output indicating the change to the K configuration and/or the change to the set B configuration that are to be used. This AI model can be hosted on the network (e.g., the gNB 920) or the UE 910.

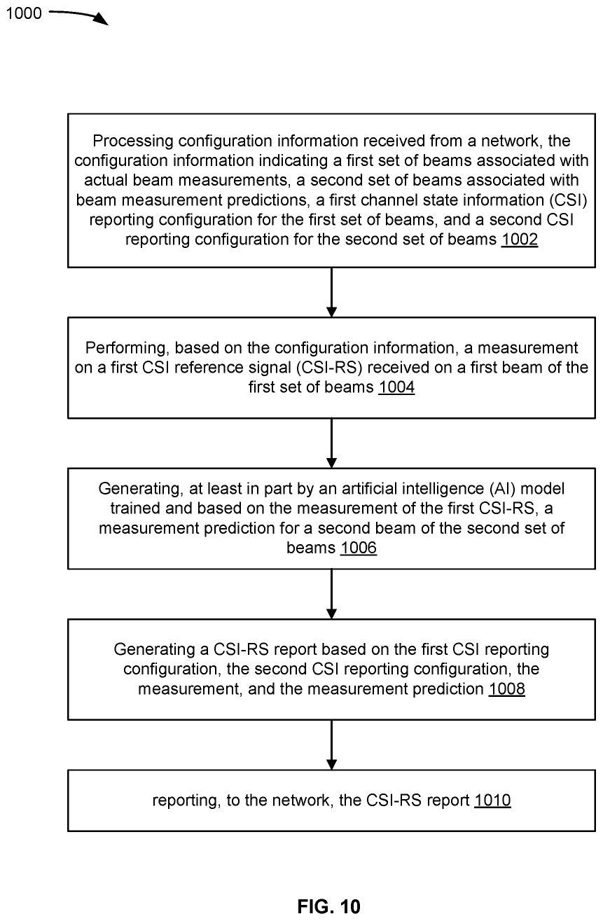

FIG. 10 illustrates an example of an operational flow/algorithmic structure 1000 for beam reporting, in accordance with some embodiments. The operational flow/algorithmic structure 1000 can be implemented by a UE (e.g., performed by components thereof including, for example, processors of the UE). The UE can be any of the UEs described herein. In some embodiments, the operational flow/algorithmic structure 1000 may be implemented by executing instructions stored in a tangible, non-transitory, computer-readable storage medium, such as a memory of the UE. While the operational flow/algorithmic structure 1000 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1000 includes, at 1002, processing configuration information received from a network, the configuration information indicating a first set of beams associated with actual beam measurements, a second set of beams associated with beam measurement predictions, a first CSI reporting configuration for the first set of beams, and a second CSI reporting configuration for the second set of beams. The configuration information can be similar to that of FIGS. 2 and 4-6, where the network can indicate to the UE different CSI reporting configurations, one for the beams to be measured, and one for the beams to be predicted.

In an example, the operational flow/algorithmic structure 1000 includes, at 1004, performing, based on the configuration information, a measurement on a first CSI-RS received on a first beam of the first set of beams. For example, the measurement is an RSRP measurement. Similar measurements can be generated based on CSI-RS received on other beams of the first set (e.g., a set B as in the above figures).

In an example, the operational flow/algorithmic structure 1000 includes, at 1006, generating, at least in part by an AI model trained and based on the measurement of the first CSI-RS, a measurement prediction for a second beam of the second set of beams. The AI model can be any of the AI-ML models described herein above and can be trained or further tuned based on the sequence diagram 300 of FIG. 3. The beam measurements generated for the first set can be input to the AI model that, in turn, outputs beam measurement predictions for the second set (e.g., a set A as in the above figures). The second beam can be one of the beams of the set A.

In an example, the operational flow/algorithmic structure 1000 includes, at 1008, generating a CSI-RS report based on the first CSI reporting configuration, the second CSI reporting configuration, the measurement, and the measurement prediction. For example, the beam measurement predictions can be reported in addition to the beam measurements, as described in FIGS. 5 and 8. Alternatively, as described in FIG. 7, the beam measurement predictions can be used to determine a set L of beams on which additional reference signals are to be transmitted and measured and only beam measurements are reported.

In an example, the operational flow/algorithmic structure 1000 includes, at 1010, reporting, to the network, the CSI-RS report. The CSI-RS report can be sent on PUSCH or PUCCH.

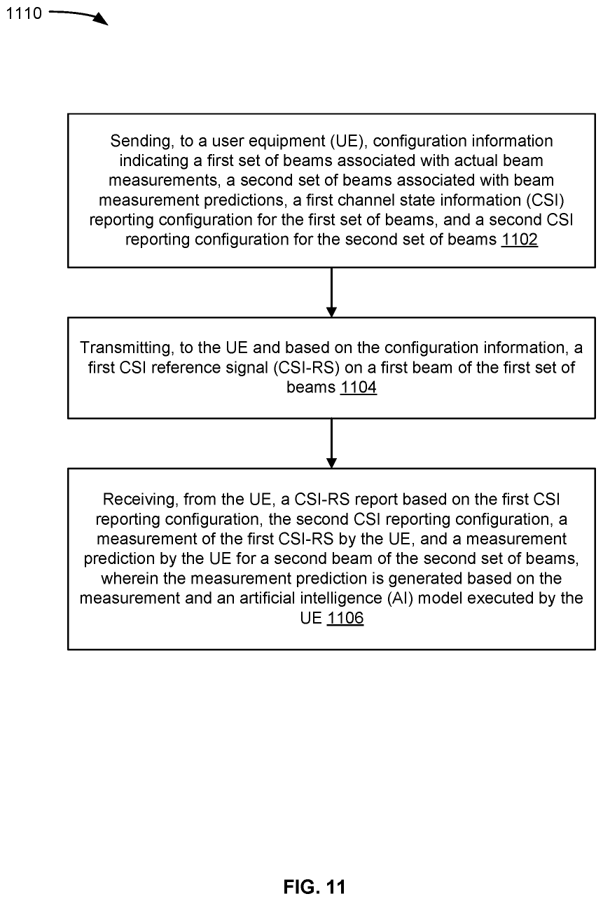

FIG. 11 illustrates another example of an operational flow/algorithmic structure 1100 for beam reporting, in accordance with some embodiments. The operational flow/algorithmic structure 1100 can be implemented by a network (e.g., by a base station thereof and/or processors of the base station). The network can be any of the networks described herein. In some embodiments, the operational flow/algorithmic structure 1100 may be implemented by executing instructions stored in a tangible, non-transitory, computer-readable storage medium, such as a memory of the base station. While the operational flow/algorithmic structure 1100 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1100 includes, at 1102, sending, to a UE, configuration information indicating a first set of beams associated with actual beam measurements, a second set of beams associated with beam measurement predictions, a first CSI reporting configuration for the first set of beams, and a second CSI reporting configuration for the second set of beams. The configuration information can be similar to that of FIGS. 2 and 4-6, where the network can indicate to the UE different CSI reporting configurations, one for the beams to be measured, and one for the beams to be predicted.

In an example, the operational flow/algorithmic structure 1100 includes, at 1104, transmitting, to the UE and based on the configuration information, a first CSI-RS on a first beam of the first set of beams (e.g., a set B as in the above figures). Additional CSI-RS can be transmitted on the remaining beams of this set. The CSI-RS can be transmitted on configured and scheduled CSI-RS resources.

In an example, the operational flow/algorithmic structure 1100 includes, at 1106, receiving, from the UE, a CSI-RS report based on the first CSI reporting configuration, the second CSI reporting configuration, a measurement of the first CSI-RS by the UE, and a measurement prediction by the UE for a second beam of the second set of beams, wherein the measurement prediction is generated based on the measurement and an AI model executed by the UE. For example, the beam measurement predictions can be reported in addition to the beam measurements, as described in FIGS. 5 and 8. Alternatively, as described in FIG. 7, the beam measurement predictions can be used to determine a set L of beams on which additional reference signals are to be transmitted and measured and only beam measurements are reported.

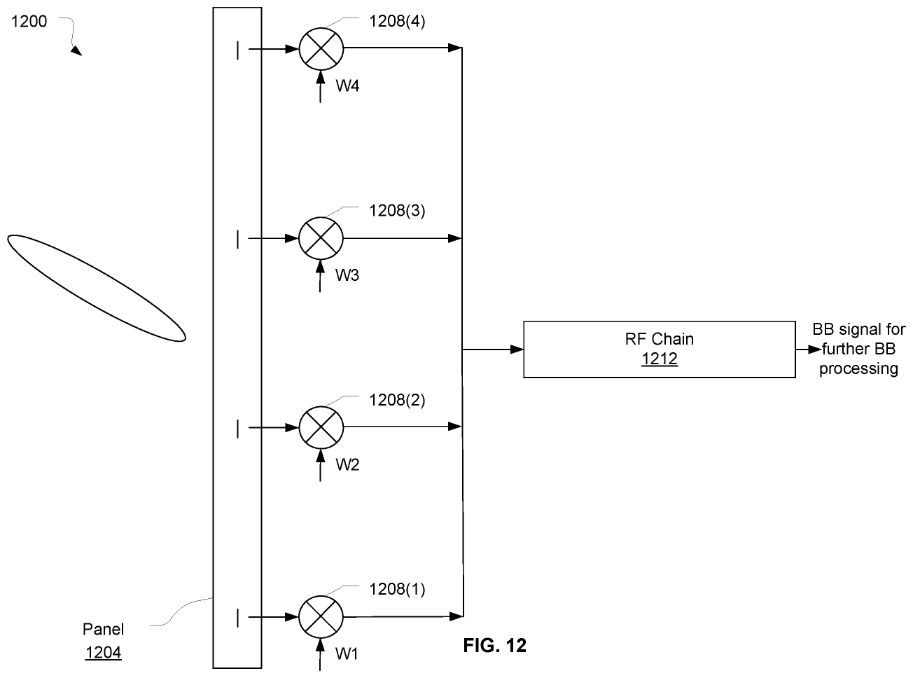

FIG. 12 illustrates receive components 1200 of the UE 104, in accordance with some embodiments. The receive components 1200 may include an antenna panel 1204 that includes a number of antenna elements. The panel 1204 is shown with four antenna elements, but other embodiments may include other numbers.

The antenna panel 1204 may be coupled to analog beamforming (BF) components that include a number of phase shifters 1208(1)-1208(4). The phase shifters 1208(1)-1208(4) may be coupled with a radio-frequency (RF) chain 1212. The RF chain 1212 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1208(1)-1208(4) to provide a receive beam at the antenna panel 1204. These BF weights may be determined based on the channel-based beamforming.

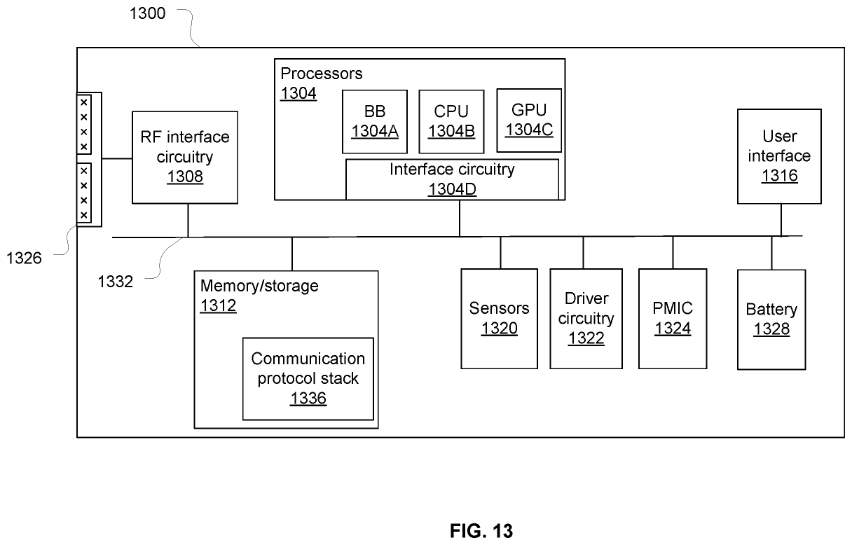

FIG. 13 illustrates a UE 1300, in accordance with some embodiments. The UE 1300 may be similar to and substantially interchangeable with UE 104 of FIG. 1. Particularly, the UE 1300 can execute an AI-ML model (e.g., one stored in its memory/storage 1312 as program code executable by one or more of its processors 1304). CSI-RS received on beams sensed by its antenna 1326 can be converted to the digital domain and processed by one or more of the processors 1304 to generate beam measurements, beam measurement predictions (as outputs of the AI-ML model), and report beam measurements and/or beam measurement predictions.

Similar to that described above with respect to UE 104, the UE 1300 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1300 may include processors 1304, RF interface circuitry 1308, memory/storage 1312, user interface 1316, sensors 1320, driver circuitry 1322, power management integrated circuit (PMIC) 1324, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, optical connection, etc. that allows various circuit components (on common or different chips or chipsets) to interact with one another.

The processors 1304 may include processor circuitry, such as baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1304A may also access group information from memory/storage 1312 to determine search space groups in which a number of repetitions of a PDCCH may be transmitted.

The memory/storage 1312 may include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1350 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1350.

In various embodiments, the RF interface circuitry 1308 may be configured to transmit/receive signals in a manner compatible with NR access technologies.

The antenna 1350 may include a number of antenna elements that each convert electrical signals into radio waves to travel through the air and to convert received radio waves into electrical signals. The antenna elements may be arranged into one or more antenna panels. The antenna 1350 may have antenna panels that are omnidirectional, directional, or a combination thereof to enable beamforming and multiple input, multiple output communications. The antenna 1350 may include microstrip antennas, printed antennas fabricated on the surface of one or more printed circuit boards, patch antennas, phased array antennas, etc. The antenna 1350 may have one or more panels designed for specific frequency bands including bands in FR1 or FR2.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1300 may power down for brief intervals of time and thus save power. If there is no data traffic activity for an extended period of time, then the UE 1300 may transition off to an RRC_Idle state, where it disconnects from the network and does not perform operations, such as channel quality feedback, handover, etc. The UE 1300 goes into a very low power state and it performs paging where again it periodically wakes up to listen to the network and then powers down again. The UE 1300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1328 may power the UE 1300, although in some examples the UE 1300 may be mounted deployed in a fixed location and may have a power supply coupled to an electrical grid. The battery 1328 may be a lithium-ion battery, a metal-air battery, such as a zinc-air battery, an aluminum-air battery, a lithium-air battery, and the like. In some implementations, such as in vehicle-based applications, the battery 1328 may be a typical lead-acid automotive battery.

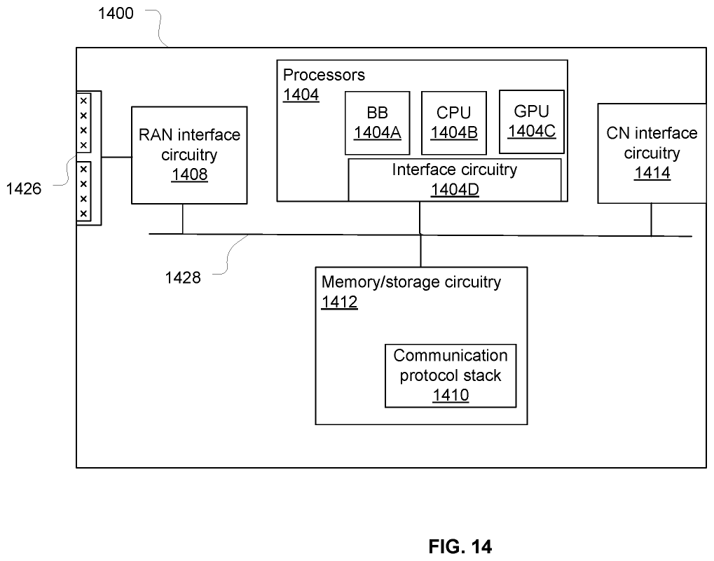

FIG. 14 illustrates a gNB 1400, in accordance with some embodiments. The gNB 1400 may be similar to and substantially interchangeable with the gNB 108 of FIG. 1. Particularly, the gNB 1400 can configure a UE with different CSI reporting configurations, can transmit via its antenna 1426 CSI-RS on beams directed to the UE, and can receive beam measurements and/or beam measurement predictions from the UE.

The gNB 1400 may include processors 1404, RAN interface circuitry 1408, core network (CN) interface circuitry 1412, and memory/storage circuitry 1416.

The components of the gNB 1400 may be coupled with various other components over one or more interconnects 1428.

The processors 1404, RAN interface circuitry 1408, memory/storage circuitry 1416 (including communication protocol stack 1410), antenna 1450, and interconnects 1428 may be similar to like-named elements shown and described with respect to FIG. 13.

The CN interface circuitry 1412 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method, the method comprising: processing configuration information received from a network, the configuration information indicating a first set of beams associated with actual beam measurements, a second set of beams associated with beam measurement predictions, a first channel state information (CSI) reporting configuration for the first set of beams, and a second CSI reporting configuration for the second set of beams; performing, based on the configuration information, a measurement on a first CSI reference signal (CSI-RS) received on a first beam of the first set of beams; generating, at least in part by an artificial intelligence (AI) model and based on the measurement of the first CSI-RS, a measurement prediction for a second beam of the second set of beams; generating a CSI-RS report based on the first CSI reporting configuration, the second CSI reporting configuration, the measurement, and the measurement prediction; and reporting, to the network, the CSI-RS report.

Example 2 includes a method, the method comprising: sending, to a user equipment (UE), configuration information indicating a first set of beams associated with actual beam measurements, a second set of beams associated with beam measurement predictions, a first channel state information (CSI) reporting configuration for the first set of beams, and a second CSI reporting configuration for the second set of beams; transmitting, to the UE and based on the configuration information, a first CSI reference signal (CSI-RS) on a first beam of the first set of beams; and receiving, from the UE, a CSI-RS report based on the first CSI reporting configuration, the second CSI reporting configuration, a measurement of the first CSI-RS by the UE, and a measurement prediction by the UE for a second beam of the second set of beams, wherein the measurement prediction is generated based on the measurement and an artificial intelligence (AI) model executed by the UE.

Example 3 includes the method of any preceding examples, wherein the first set of beams is a first subset of the second set of beams, wherein the CSI-RS report includes a first report that corresponds to the first subset and includes the actual beam measurements, and wherein the CSI-RS report further includes a second report that corresponds to a second subset of the second set of beams and that includes the beam measurement predictions.

Example 4 includes the method of any preceding examples, wherein a size of the second subset is K, and wherein the configuration information indicates K.

Example 5 includes the method of example 4, wherein a value of K is dynamically defined based on a network condition that includes at least one of: a signal-to-noise ratio (SNR), a Doppler effect, or a delay spread.

Example 6 includes the method of example 4, wherein a size of the second subset is K and is based on the AI model.

Example 7 includes the method of any preceding examples, wherein the measurement is a first measurement, and wherein the method further comprises: performing a second measurement on a second CSI-RS, wherein the second CSI-RS is received on the second beam based on the measurement prediction, and wherein the CSI-report includes the second measurement.

Example 8 includes the method of example 6, further comprising: sending, to the network, the measurement prediction separately from the CSI-RS report.

Example 9 includes the method of any preceding examples, wherein the configuration information indicates that further CSI processing is needed for a subset of the second set of beams, the subset having a size K, and wherein the method further comprises: determining that the second beam belongs to the subset and is excluded from the first set of beams; requesting the network to transmit a second CSI-RS on the second beam based on the second beam belonging to the subset, the second CSI-RS being a periodic CSI-RS or an aperiodic CS-RS; performing a second measurement on the second CSI-RS; and including the second measurement in the CSI-RS report.

Example 10 includes the method of any preceding examples, wherein the configuration information indicates that a subset of the second set of beams is to be further processed, the subset having a size K, the subset having a size K, and wherein the method further comprises: determining K beams of the second set of beams based on the beam measurement predictions, wherein the beam measurement predictions are output by the AI model, and wherein the K beams include the second beam; indicating, to the network, indices of the K beams; performing a second measurement on a second CSI-RS received on the second beam, the second CSI-RS transmitted from the network based on the indices of the K beams; and including the second measurement in the CSI-RS report.

Example 11 includes the method of example 10, further comprising: determining that the second beam is excluded from the first set; and requesting the network to transmit the second CSI-RS on the second beam based on the second beam being excluded from the first set.

Example 12 includes the method of any preceding examples, wherein the CSI-RS report is a first CSI-RS report, wherein the configuration information indicates that a subset of the second set of beams is to be further processed, the subset having a size K, and wherein the method further comprises: determining K beams of the second set of beams based on the beam measurement predictions, wherein the beam measurement predictions are output by the AI model, and wherein the K beams include the second beam; reporting, to the network, a second CSI report that includes K beam measurement predictions of the beam measurement predictions, the K beam measurement predictions corresponding to the K beams; performing a second measurement on a second CSI-RS received on the second beam, the second CSI-RS transmitted from the network based on the K beams; and including the second measurement in the first CSI-RS report.

Example 13 includes the method of example 12, further comprising: determining that the second beam is excluded from the first set; and requesting the network to transmit the second CSI-RS on the second beam based on the second beam being excluded from the first set.

Example 14 includes the method of example 12, wherein at least one of: the AI model, use of the AI model, or the configuration information is updated based on the first CSI-RS report and the second CSI-RS report.

Example 15 includes the method of any preceding examples, wherein the configuration information indicates that a subset of the second set of beams is to be further processed, the subset having a size K, and wherein a value of K is dynamically defined based on a network condition that includes at least one of: a signal-to-noise ratio (SNR), a Doppler effect, or a delay spread.

Example 16 includes the method of any preceding examples, wherein the CSI-RS report is a first CSI-RS report, wherein the configuration information indicates that a subset of the second set of beams is to be further processed, the subset having a size K, and wherein the method further comprises: receiving, from the UE, a second CSI report that includes K beam measurement predictions corresponding to K beams of the second set of beams, wherein the K beams include the second beam; and transmitting, to the UE, a second CSI-RS on the second beam based on the K beams, and wherein the first CSI-RS report includes a
measurement of the second CSI-RS instead of the measurement prediction.

Example 17 includes the method of example 16, further comprising: indicating, to the UE and based on the first CSI report and the second CSI report, at least one of: that the AI model is to be deactivated or that only actual measurements using the first set of beams are to be reported.

Example 18 includes the method of example 16, further comprising: indicating, to the UE and based on the first CSI report and the second CSI report, at least one of: to switch to using a different AI model for beam management, update parameters of the AI model, initiate a transfer procedure to receive an additional AI model, or initiate a data collection procedure to further train the AI model.

Example 19 includes the method of example 16, further comprising: determining, by the UE and based on the first CSI report and the second CSI report, a change to at least one of: the first set of beams or the subset of the second set of beams, wherein the change is signaled by the network to the UE as a configuration update or is determined based on an update procedure, wherein the update procedure is triggered by the network and includes data collection by the UE and an update, based on the data collection, to a model configured to indicate the change.

Example 20 includes a user equipment (UE) or an apparatus comprising: one or more processors; and one or more memory storing instructions that, upon execution by the one or more processors, configure the UE or the apparatus to perform a method described in or related to any of the preceding examples.

Example 21 includes one or more computer-readable media storing instructions that, when executed on a user equipment (UE) or an apparatus, cause the UE or the apparatus to perform operations comprising those of a method described in or related to any of the preceding examples.

Example 22 includes an apparatus comprising means to perform one or more elements of a method described in or related to any of the preceding examples.

Example 23 includes one or more non-transitory computer-readable media comprising instructions to cause an apparatus, upon execution of the instructions by one or more processors of the apparatus, to perform one or more elements of a method described in or related to any of the preceding examples.

Example 24 includes an apparatus comprising logic, modules, or processing circuitry configured to perform one or more elements of a method described in or related to any of the preceding examples.

Example 25 includes an apparatus, a network, a base station, or a system comprising: one or more processors and one or more computer-readable media comprising instructions that, when executed by the one or more processors, cause the one or more processors to perform one or more elements of a method described in or related to any of the preceding examples.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. A method comprising:
processing configuration information received from a network, the configuration information indicating a first set of beams associated with actual beam measurements, a second set of beams associated with beam measurement predictions, a first channel state information (CSI) reporting configuration for the first set of beams, and a second CSI reporting configuration for the second set of beams;
performing, based on the configuration information, a measurement on a first CSI reference signal (CSI-RS) received on a first beam of the first set of beams;
generating, at least in part by an artificial intelligence (AI) model and based on the measurement of the first CSI-RS, a measurement prediction for a second beam of the second set of beams;
generating a CSI-RS report based on the first CSI reporting configuration, the second CSI reporting configuration, the measurement, and the measurement prediction; and
reporting, to the network, the CSI-RS report.

2. The method of claim 1, wherein the first set of beams is a first subset of the second set of beams, wherein the CSI-RS report includes a first report that corresponds to the first subset and includes the actual beam measurements, and wherein the CSI-RS report further includes a second report that corresponds to a second subset of the second set of beams and that includes the beam measurement predictions.

3. The method of claim 2, wherein a size of the second subset is K, and wherein the configuration information indicates K.

4. The method of claim 3, wherein a value of K is dynamically defined based on a network condition that includes at least one of: a signal-to-noise ratio (SNR), a Doppler effect, or a delay spread.

5. The method of claim 2, wherein a size of the second subset is K and is based on the AI model.

6. The method of claim 1, wherein the measurement is a first measurement, and wherein the method further comprises:
performing a second measurement on a second CSI-RS, wherein the second CSI-RS is received on the second beam based on the measurement prediction, and wherein the CSI-report includes the second measurement.

7. The method of claim 6, further comprising:
sending, to the network, the measurement prediction separately from the CSI-RS report.

8. The method of claim 1, wherein the configuration information indicates that further CSI processing is needed for a subset of the second set of beams, the subset having a size K, and wherein the method further comprises:
determining that the second beam belongs to the subset and is excluded from the first set of beams;
requesting the network to transmit a second CSI-RS on the second beam based on the second beam belonging to the subset, the second CSI-RS being a periodic CSI-RS or an aperiodic CS-RS;
performing a second measurement on the second CSI-RS; and
including the second measurement in the CSI-RS report.

9. The method of claim 1, wherein the configuration information indicates that a subset of the second set of beams is to be further processed, the subset having a size K, the subset having a size K, and wherein the method further comprises:
determining K beams of the second set of beams based on the beam measurement predictions, wherein the beam measurement predictions are output by the AI model, and wherein the K beams include the second beam;
indicating, to the network, indices of the K beams;
performing a second measurement on a second CSI-RS received on the second beam, the second CSI-RS transmitted from the network based on the indices of the K beams; and
including the second measurement in the CSI-RS report.

10. The method of claim 9, further comprising:
determining that the second beam is excluded from the first set; and
requesting the network to transmit the second CSI-RS on the second beam based on the second beam being excluded from the first set.

11. An apparatus comprising:
a receiver;
a transmitter; and
processing circuitry communicatively couple with the receiver and the transmitter and configured to:
process configuration information received from a network, the configuration information indicating a first set of beams associated with actual beam measurements, a second set of beams associated with beam measurement predictions, a first channel state information (CSI) reporting configuration for the first set of beams, and a second CSI reporting configuration for the second set of beams;
perform, based on the configuration information, a measurement on a first CSI reference signal (CSI-RS) received on a first beam of the first set of beams;
generate, at least in part by an artificial intelligence (AI) model and based on the measurement of the first CSI-RS, a measurement prediction for a second beam of the second set of beams;
generate a CSI-RS report based on the first CSI reporting configuration, the second CSI reporting configuration, the measurement, and the measurement prediction; and
report, to the network, the CSI-RS report.

12. The apparatus of claim 11, wherein the CSI-RS report is a first CSI-RS report, wherein the configuration information indicates that a subset of the second set of beams is to be further processed, the subset having a size K, and wherein the processing circuitry is further configured to:
determine K beams of the second set of beams based on the beam measurement predictions, wherein the beam measurement predictions are output by the AI model, and wherein the K beams include the second beam;
report, to the network, a second CSI report that includes K beam measurement predictions of the beam measurement predictions, the K beam measurement predictions corresponding to the K beams;
perform a second measurement on a second CSI-RS received on the second beam, the second CSI-RS transmitted from the network based on the K beams; and
include the second measurement in the first CSI-RS report.

13. The apparatus of claim 12, wherein the processing circuitry is further configured to:
determine that the second beam is excluded from the first set; and
request the network to transmit the second CSI-RS on the second beam based on the second beam being excluded from the first set.

14. The apparatus of claim 12, wherein at least one of: the AI model, use of the AI model, or the configuration information is updated based on the first CSI-RS report and the second CSI-RS report.

15. A method comprising:
sending, to a user equipment (UE), configuration information indicating a first set of beams associated with actual beam measurements, a second set of beams associated with beam measurement predictions, a first channel state information (CSI) reporting configuration for the first set of beams, and a second CSI reporting configuration for the second set of beams;
transmitting, to the UE and based on the configuration information, a first CSI reference signal (CSI-RS) on a first beam of the first set of beams; and
receiving, from the UE, a CSI-RS report based on the first CSI reporting configuration, the second CSI reporting configuration, a measurement of the first CSI-RS by the UE, and a measurement prediction by the UE for a second beam of the second set of beams, wherein the measurement prediction is generated based on the measurement and an artificial intelligence (AI) model executed by the UE.

16. The method of claim 15, wherein the configuration information indicates that a subset of the second set of beams is to be further processed, the subset having a size K, and wherein a value of K is dynamically defined based on a network condition that includes at least one of: a signal-to-noise ratio (SNR), a Doppler effect, or a delay spread.

17. The method of claim 15, wherein the CSI-RS report is a first CSI-RS report, wherein the configuration information indicates that a subset of the second set of beams is to be further processed, the subset having a size K, and wherein the method further comprises:
receiving, from the UE, a second CSI report that includes K beam measurement predictions corresponding to K beams of the second set of beams, wherein the K beams include the second beam; and
transmitting, to the UE, a second CSI-RS on the second beam based on the K beams, and wherein the first CSI-RS report includes a measurement of the second CSI-RS instead of the measurement prediction.

18. The method of claim 17, further comprising:
indicating, to the UE and based on the first CSI report and the second CSI report, at least one of: that the AI model is to be deactivated or that only actual measurements using the first set of beams are to be reported.

19. The method of claim 17, further comprising:
indicating, to the UE and based on the first CSI report and the second CSI report, at least one of: to switch to using a different AI model for beam management, update parameters of the AI model, initiate a transfer procedure to receive an additional AI model, or initiate a data collection procedure to further train the AI model.

20. The method of claim 17, further comprising:
determining, by the UE and based on the first CSI report and the second CSI report, a change to at least one of: the first set of beams or the subset of the second set of beams, wherein the change is signaled by the network to the UE as a configuration update or is determined based on an update procedure, wherein the update procedure is triggered by the network and includes data collection by the UE and an update, based on the data collection, to a model configured to indicate the change.
